(19) United States
(12) Patent Application Publication
(10) Pub. No.: US 2012/0290130 A1
(43) Pub. Date: Nov. 15, 2012

(54) Method to Model and Program a Robotic Workcell

(75) Inventor: Chetan Kapoor, Austin, TX (US)

(73) Assignee: AGILE PLANET, INC., Austin, TX (US)

(21) Appl. No.: 13/465,100

(22) Filed: May 7, 2012

Related U.S. Application Data
(60) Provisional application No. 61/484,415, filed on May 10, 2011.

(51) Int. Cl. G05B 19/418; G06F 19/00; G06F 17/50

(52) U.S. Cl. 700/247; 703/1; 700/245; 700/254

(57) ABSTRACT

An improved method to model and program a robotic workcell. Two-dimensional (2D) images of a physical workcell are captured to facilitate, in part, initial integration of any preexisting three-dimensional (3D) component models into a 3D model workcell. 3D models of other essential workcell components are synthesized and integrated into the 3D workcell model. The robot is then configured and programmed. The resultant 3D workcell model more faithfully reflects the “as-built” workcell than a traditional model that represents the “as-designed” workcell.

### CROSS-REFERENCE TO RELATED APPLICATIONS

This application claims priority to U.S. Provisional Application Ser. No. 61/484,415 filed 10 May 2011 (“Parent Provisional”) and hereby claims benefit of the filing dates thereof pursuant to 37 CFR §1.78(a)(4).

This application contains subject matter generally related to U.S. application Ser. No. 12/910,124 filed 22 Oct. 2010 (“Related Co-application”), assigned to the assignee hereof.

The subject matter of the Parent Provisional and the Related Co-application (collectively, “Related References”), each in its entirety, is expressly incorporated herein by reference.

### FIELD OF THE INVENTION

The present invention relates generally to robot programming methodologies, and, in particular, robot-programming methods in the context of workcells.

### BACKGROUND OF THE INVENTION

In general, in the descriptions that follow, I will italicize the first occurrence of each special term of art that should be familiar to those of ordinary skill in the art of industrial robot programming and simulation. In addition, when I first introduce a term that I believe to be new or that I will use in a context that I believe to be new, I will bold the term and provide the definition that I intend to apply to that term. In addition, throughout this description, I will sometimes use the terms assert and negate when referring to the rendering of a signal, signal flag, status bit, or similar apparatus into its logically true or logically false state, respectively, and the term toggle to indicate the logical inversion of a signal from one logical state to the other. Alternatively, I may refer to the mutually exclusive boolean states as logic_{—}0 and logic_{—}1. Of course, as is well known, consistent system operation can be obtained by reversing the logic sense of all such signals, such that signals described herein as logically true become logically false and vice versa. Furthermore, it is of no relevance in such systems which specific voltage levels are selected to represent each of the logic states.

Robot programming methodologies have not changed much since the dawn of the programmable industrial robot over fifty years ago when, in 1961, Unimate, a die-casting robot, began working on the General Motors assembly line. Unimate was programmed by recording joint coordinates during a teaching phase, and then replaying these joint coordinates during a subsequent, operational phase. Joint coordinates are the angles of the hydraulic joints that comprise the robotic arm. Somewhat similarly, with today's robots, workcells and associated peripheral systems, a more commonly used technique allows the programming of the robotic task by recording positions of interest, and then developing an application program that moves the robot through these positions of interest based on the application logic. Some improvements have been made in this technique, and, in particular, in the use of a graphical interface to specify application logic. These improvements notwithstanding, moving the physical robot to positions of interest is still needed.

Analogous programming techniques to those previously described have been developed, but, in lieu of the physical environment described previously, a virtual environment is used for programming the robot and its associated workcell. The physical environment comprises the physical robot and such other items as would be normally present within the workcell. The virtual environment comprises a 3-dimensional (“3D”) computer model of the physical robot as well as 3D or 2-dimensional (“2D”) models of the other items within the workcell. Some of these virtual environments have integrated computer-aided design (“CAD”) capabilities, and allow the user to point and click on a position of interest, thereby causing the simulated robot to move to that point. Features such as these reduce the manual effort required to jog or drive the robot to the intended position in 3D space.

A known alternative method for programming a robot involves limited teaching of positions and identification of target positions for robotic motion using real-time sensor feedback, such as a vision system. Methods such as these reduce the teaching effort. However, these methods also serve to transfer additional effort to the programming and calibration of vision systems associated with the target identification system. Application logic controlling robotic motion to the identified target position, e.g., path specification, speed specification, etc., still must be specified by the application developer.

One additional method of robot programming involves teaching specific positions to the robot and the application logic by literally grasping the robot's end-effector, and manually moving it through the specific positions, steps and locations necessary to accomplish the task. This technique is used to teach the robot the path to follow, along with specific positions and some application logic. This technique has not seen wide acceptance due to safety concerns. The safety concerns include the fact the robot must be powered during this process, as well as concerns related to the size discrepancy between the human operator and a robot that may be significantly larger than the operator. An advantage of this approach is that an operator can not only teach the path and the positions, but can also teach the resistive force that the robot needs to apply to the environment when intentional contact is made.

The aforementioned methods of robotic and workcell programming generally suffer from laborious and time consuming iterations between teaching and programming the robotic environment, testing the robotic environment under physical operating conditions, and resolving discrepancies. What is needed is a method of robot programming that encompasses the capabilities of the above described methods but significantly automates the process of robot programming by merging the aforementioned capabilities provided by 3D simulation, image processing, scene segmentation, touch user interfaces, and robot control and simulation algorithms.

### BRIEF SUMMARY OF THE INVENTION

In accordance with a preferred embodiment of my invention, I provide a method of developing a 3-dimensional (3D) model of a robotic workcell comprising a plurality of components, including at least a robot, at least one of the components having a predefined 3D model. According to this method, I first capture one or more images of the workcell, as may be necessary to capture all critical workcell components positioned such that they may obstruct, in whole or in part, at least one potential motion path of the robot. Next, I integrate each preexisting 3D component model into a 3D model of the workcell. Preferably, during integration, I calibrate each such preexisting model against the respective workcell images. I now synthesize from the workcell image(s) a 3D model for the other essential workcell components. I then integrate all such synthesized 3D component models into the 3D workcell model. As noted above, during integration, I prefer to calibrate each such synthesized model against the respective workcell images. Optionally, I can define workcell constraints into the 3D workcell model.

In one other embodiment, I provide a method of robotic and workcell programming. According to this method, I first instantiate a workcell comprising a plurality of components, including at least a robot. Usually, the manufacturer of at least one workcell component, e.g., the robot, will provide a 3D model of that component. Second, I capture one or more images of the workcell, as may be necessary to capture all critical workcell components positioned such that they may obstruct, in whole or in part, at least one potential motion path of the robot. Next, I integrate each preexisting 3D component model into a 3D model of the workcell. Preferably, during integration, I calibrate each preexisting model against the respective workcell images. I now synthesize from the workcell image(s) 3D models for the other essential workcell components. I then integrate all synthesized 3D component models into the 3D workcell model. As noted above, during integration, I prefer to calibrate each synthesized model against the respective workcell images. I can now configure the robot. Finally, I program the robot. Optionally, I can define workcell constraints into the 3D workcell model. Also, I prefer to perform a final integration of the 3D workcell model to assure conformance to the physical workcell as captured in the images.

I submit that each of these embodiments of my invention provides for a method of robot programming that significantly reduces the time to operation of the robot and associated workcell, the capability and performance being generally comparable to the best prior art techniques while requiring fewer programming and environment iterations than known implementation of such prior art techniques.

### BRIEF DESCRIPTION OF THE SEVERAL VIEWS OF THE DRAWINGS

My invention may be more fully understood by a description of certain preferred embodiments in conjunction with the attached drawings in which:

FIG. 1 illustrates, in partial perspective form, a physical workcell in which my programming method will be utilized, in accordance with my invention;

FIG. 2 illustrates, in flow-diagram form, my method of developing a 3D model of the physical workcell.

In the drawings, similar elements will be similarly numbered whenever possible. However, this practice is simply for convenience of reference and to avoid unnecessary proliferation of numbers, and is not intended to imply or suggest that my invention requires identity in either function or structure in the several embodiments.

### DETAILED DESCRIPTION OF THE INVENTION

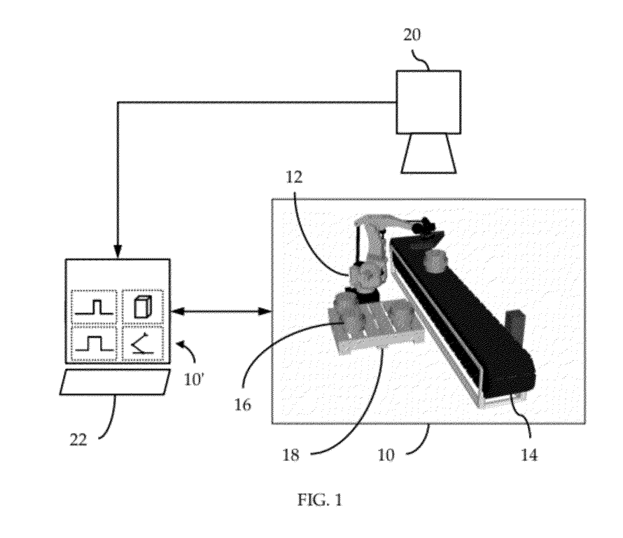

Illustrated in FIG. 1 is a typical instantiation of the types and configuration of hardware components that will comprise a fully operational, physical workcell 10. By way of example, the workcell 10 comprises a robot 12 and a peripheral device 14 adapted sequentially to convey a series of workpieces 16 from a location outside the workcell 10 into the workcell 10 for transfer by the robot 12 to a pallet 18; of course, if desired, the workcell 10 can be reconfigured such that the robot 12 sequentially transfers a series of workpieces 16 from the pallet 18 onto the peripheral device 14 for conveyance to a location outside of the workcell 10.

Associated with workcell 10 is at least one camera system 20 positioned so as continuously to provide to a robot control system 22 precise location information on each of the workpieces 16 being conveyed by the peripheral device 14 toward the robot 12. In particular, my control system 22 is specially adapted to perform a number of computing tasks such as: activating, controlling and interacting with the physical workcell 10; developing a 3D model 10′ of the workcell 10, and simulating the operation of the model workcell 10′; performing analysis on data gathered during such a simulation or interaction; and the like. One such control system 22, with certain improvements developed by me, is more fully described in my Related Co-application.

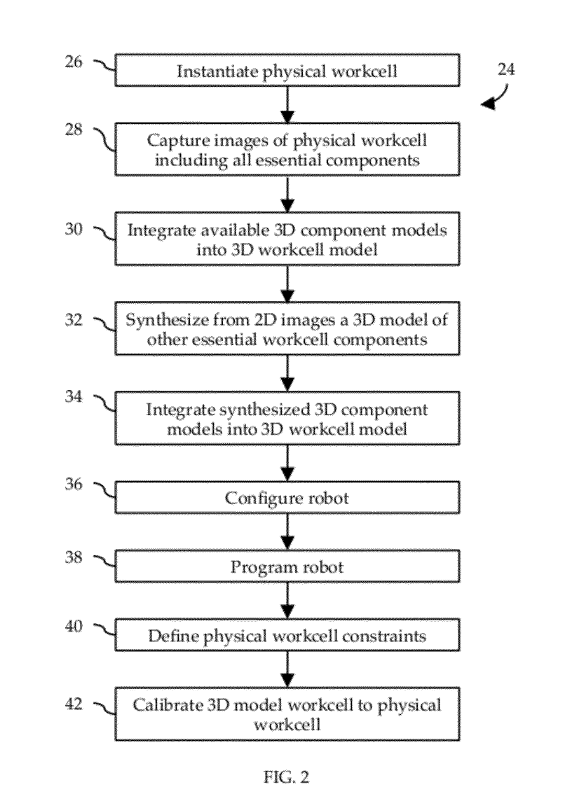

Illustrated in FIG. 2 is a workcell programming method 24 in accordance with a preferred embodiment of my invention. I first instantiate the physical workcell 10 (step 26). I then capture as many discrete, digital images, taken from various distances and perspectives, as may be required to develop a sufficiently precise 3D model of each essential component comprising the physical workcell 10 (step 28). Of course, it may be necessary, from time to time, to capture additional images from additional distances or perspectives. However, with experience, it usually becomes possible to capture all essential images at this step of my method.

Typically, the manufacturer of the robot 12 will develop and provide to its customers a 3D software model of robot 12, including all joints, links and, often, end-effectors. In some cases, the manufacturer of the peripheral device 14 will develop and provide to its customers a 3D software model of peripheral device 14, including all stationary and mobile components, directions and speeds of motion, and related details. Now, I can sequentially integrate each such component model into a single, unified 3D workcell model 10′ (sometimes referred to in this art as a “world frame”) of the physical workcell 10 (step 30). During integration, each of the individual 3D component models must be calibrated to the captured images. In general, I prefer to employ a suitable input device, e.g., a touch screen, to overlay the respective component model on the relevant images, and then, using known scaling, rotational and translational algorithms, adjust the physical dimensions, angular orientation and cartesian coordinates of the component model to conform to the respective imaged physical component. After integrating all available component models, the workcell model 10′ comprises a simple yet precise simulacra of the physical workcell 10.

Using the captured 2D images, I now synthesize, using known scene segmentation techniques including edge detection algorithms, clustering methods and the like, a 3D model of each essential workcell component (step 32). Once I have processed enough 2D images of a selected component to synthesize a sufficiently precise 3D model of that component, I can now integrate that component's model into the larger 3D workcell model 10′ (step 34). During integration, I calibrate each synthesized component model with its corresponding component images. As will be clear to those skilled in this art, there are, in general, very few components within the physical workcell 10 that must be calibrated with close precision, e.g., within, say plus or minus a few tenths of an inch. This makes good sense when you consider that one primary purpose for constructing the full model workcell 10′ is to determine which physical obstructions the robot 12 may possibly encounter throughout its entire range of motion; indeed, in some applications, it may be deemed unnecessary to model any physical component or fixed structure that is determined to be fully outside the range of motion of the robot 12.

Now that I have a sufficiently precise model workcell 10′, I configure the robot 12 as it will exist during normal operation, including the intended end-effector(s), link attachments (e.g., intrusion detectors, pressure/torque sensors, etc.), and the like (step 36). Of course, if desired, such configuration may be performed during instantiation of the physical workcell 10 (see, step 26). However, I have found it convenient to perform configuration at this point in my method as it provides a convenient re-entrant point in the flow, and facilitates rapid adaptation of the workcell model 10′ to changes in the configuration of the robot 12 during normal production operation.

At this point, I can program the robot 12 using known techniques including touch screen manipulation, teaching pendant, physical training, and the like (step 38). In my Related Co-application I have described suitable programming techniques. Either during or after programming, I define constraints on the possible motions of the robot 12 with respect to all relevant components comprising the physical workcell 10 (step 40). Various techniques are known for imposing constraints, but I prefer to use a graphical user interface, such as that illustrated in the display portion of my control system 22 (see, FIG. 1). For example, using the control system 22 I can quickly query the control parameters for each joint of the robot 12, and manually implement appropriate motion restrictions. In addition, for other components integrated into the model workcell 10′, I can now define appropriate interference zones which, if intruded by the robot 12 during production operation, will trigger an appropriate exception event.

Finally, I calibrate the full workcell model 10′ against the physical workcell 10 (step 42). As noted above, I need only calibrate those entities of interest, i.e., those physical components (or portions thereof) that, during normal production operation, the robot 12 can be expected to encounter. In general, passive components, including fixed structures and the like, can be protected using appropriate interference zones (see, step 40). Greater care and precision is required, however, to properly protect essential production components, including the work pieces 16, the pallet 18 and some surfaces of the peripheral device 14. Using the techniques disclosed above, I now improve the precision with which my model workcell 10′ represents such critical components, adding when possible appropriate constraints on link speed, joint torque, and end-effector orientation and pressure.

As may be expected, my method 24 is recursive in nature, and is intentionally constructed to facilitate “tweaking” of both the model workcell 10′ and the program for the robot 12 to accommodate changes in the physical workcell 10, flow of workpieces 16, changes in the configuration of the robot 12, etc. For significant changes, it may be necessary to loop back all the way to step 28; for less significant changes, it may be sufficient to loop back to step 36. Other recursion paths may also be appropriate in particular circumstances.

Also, although I have described my preferred method as comprising calibration at certain particular points during the development of the 3D model workcell 10′, it will be evident to those skilled in this art that calibration can be advantageously performed at other points, but at a resulting increase in model development time and cost. For example, it would certainly be feasible to perform partial calibrations of both preexisting and synthesized 3D component models with respect to each separate image captured of the physical workcell 10, with each successive partial calibration contributing to the end precision of the 3D model workcell 10′. In addition, as has been noted, once a fully-functional 3D model workcell 10′ has been developed, it can be further calibrated (or, perhaps, recalibrated) against the physical workcell 10, e.g., by: enabling the operator to move the end-effector of the robot 12, using only the 3D model workcell 10′, to a given point, say, immediately proximate (almost touching) a selected element of the peripheral device 14; measuring any positional error in all 6-dimensional axes; and calibrating the 3D model workcell 10′ to compensate for the measured errors in the physical workcell 10.

In summary, the methods described simplifies the programming of workcell 10 by combining the benefits of CAD based offline robot 12 programming with the accuracy of programming achieved by manual teaching of the robot 12 at the physical workcell. This method does so by using predefined CAD models of known objects, such as those available for the robot 12, and using them to calibrate against an image of the actual workcell 10. The built-in cameras and multi-touch interface provided by the computing device 22, which may include a tablet computer, allow for actual workcell 10 image capture, and a simplified way to enter robot application logic such as robot path, speed, interference zones, user frames, tool properties, and the like.

Thus it is apparent that I have provided methods from robot modeling and programming that encompasses the capabilities of the above described methods, but significantly automates the process of robot modeling and programming by merging the aforementioned capabilities provided by 3D simulation, image processing, scene segmentation, multi-touch user interfaces, and robot control and simulation algorithms. In particular, I submit that my method and apparatus provides performance generally comparable to the best prior art techniques while requiring fewer iterations and providing better accuracy than known implementations of such prior art techniques. Therefore, I intend that my invention encompass all such variations and modifications as fall within the scope of the appended claims.

What I claim is:

1. A method of developing a 3-dimensional (3D) model of a robotic workcell, said workcell comprising a plurality of components, said plurality of components comprising a robot, at least a first of said components having a predefined 3D model, the method comprising the steps of:
capturing an image of said workcell;
integrating the first 3D component model into a 3D model of said workcell;
synthesizing from said image of said workcell a 3D model of a second component; and
integrating said second 3D component model into said 3D workcell model.

2. The method of claim 1 wherein said step of integrating said first 3D component model into said 3D workcell model is further characterized as comprising calibrating said first 3D component model to said image.

3. The method of claim 2 wherein said step of integrating said second 3D component model into said 3D workcell model is further characterized as comprising calibrating said second 3D component model to said image.

4. The method of claim 1 wherein said step of integrating said second 3D component model into said 3D workcell model is further characterized as comprising calibrating said second 3D component model to said image.

5. The method of claim 1 wherein said synthesizing step is further characterized as synthesizing the second 3D component model by at least a selected one of segmenting, rotating, translating and scaling said image of said workcell.

6. The method of claim 1 further comprising the additional step of:
defining workcell constraints.

7. The method of claim 1 wherein said plurality of components is further characterized as comprising:
the robot; and
a peripheral device adapted to convey a workpiece to the robot.

8. The method of claim 1 wherein said plurality of components is further characterized as comprising:
the robot; and
a peripheral device adapted to convey a workpiece from the robot.

9. The method of claim 1 wherein said plurality of components is further characterized as comprising:
the robot;
a peripheral device adapted to convey a workpiece to the robot;
a camera adapted continuously to provide precise location information on the workpiece being conveyed by the peripheral device to the robot; and
a control system coupled to the robot and the camera, the control system adapted to control the robot in accordance with the programming, subject to the workcell constraints and the location information.

10. A method of robotic and workcell programming, the method comprising the steps of:
instantiating a workcell, said workcell comprising a plurality of components, said plurality of components comprising a robot;
capturing an image of said workcell;
integrating a first 3-dimensional (3D) component model into a 3D model of said workcell;
synthesizing a second 3D component model from said image of said workcell;
integrating said second 3D component model into said 3D workcell model;
configuring said robot; and
programming said robot.

11. The method of claim 10 wherein said step of integrating said first 3D component model into said 3D workcell model is further characterized as comprising calibrating said first 3D component model to said image.

12. The method of claim 11 wherein said step of integrating said second 3D component model into said 3D workcell model is further characterized as comprising calibrating said second 3D component model to said image.

13. The method of claim 10 wherein said step of integrating said second 3D component model into said 3D workcell model is further characterized as comprising calibrating said second 3D component model to said image.

14. The method of claim 10 wherein said synthesizing step is further characterized as synthesizing the second 3D component model by at least a selected one of segmenting, rotating, translating and scaling said image of said workcell.

15. The method of claim 10 further comprising the additional step of:
defining workcell constraints.

16. The method of claim 15 further comprising the additional step of:
calibrating said 3D workcell model.

17. The method of claim 10 wherein said plurality of components is further characterized as comprising:
the robot; and
a peripheral device adapted to convey a workpiece to the robot.

18. The method of claim 10 wherein said plurality of components is further characterized as comprising:
the robot; and
a peripheral device adapted to convey a workpiece from the robot.

19. The method of claim 10 wherein said plurality of components is further characterized as comprising:
the robot; and
a control system coupled to the robot, the control system adapted to control the robot in accordance with the programming, subject to the workcell constraints.

20. The method of claim 10 wherein said plurality of components is further characterized as comprising:
the robot;
a peripheral device adapted to convey a workpiece to the robot;
a camera adapted continuously to provide precise location information on the workpiece being conveyed by the peripheral device to the robot; and
a control system coupled to the robot and the camera, the control system adapted to control the robot in accordance with the programming, subject to the workcell constraints and the location information.
